(19) United States
(12) Patent Application Publication
(10) Pub. No.: US 2010/0121630 A1
(43) Pub. Date: May 13, 2010

(54) LANGUAGE PROCESSING SYSTEMS AND METHODS

(75) Inventors: Michael Mende, Bammental (DE); Yaron Bruckner, Monaco (MC)

Correspondence Address: KNOBBE MARTENS OLSON & BEAR LLP, 2040 MAIN STREET, FOURTEENTH FLOOR, IRVINE, CA, 92614, US

(73) Assignee: Lingupedia Investments S. a r. l., Luxembourg (LU)

(21) Appl. No.: 12/267,461

(22) Filed: Nov. 7, 2008

(51) Int. Cl. G06F 17/28

(52) U.S. Cl. 704/7

(57) ABSTRACT

Embodiments of the present disclosure include an electronic translation system employing a language-independent central representation of language to be translated. The system may include a language parser to translate to the language-independent representation, and a renderer to translate from the representation to a desired language supported by the system. In an embodiment, users of the translation system can add or modify their own languages.

### BACKGROUND

1. Field of the Invention

The present disclosure relates in general to translation systems and, more particularly, to online translation systems.

2. Description of Related Art

Processing natural language using electronic translation systems can be problematic. Natural language includes of a sequence of words arranged in a specific manner to expresses a certain meaning. Strongly simplified, electronic translators may analyze input text sequences by reviewing the sequence word-by-word. Unfortunately, these word-by-word systems employing isolated analysis may not retrieve the intended meaning of the sequence. Rather, before electronic translation systems can produce intended meanings of input text sequences, their algorithms need to apply syntax. Used generally, “syntax” includes the rules and principles that govern sentence structure of a language.

For example, an electronic translator may process an input text sequence according to a process shown in FIG. 1. In Block 100, a user may enter an input text sequence for translation through, for example, a user interface, an electronic document, or the like. In Block 102, the electronic translator may parse the sequence based on the syntax rules of the source language. In Block 104, the electronic translator may perform dictionary look-up using the input language as an index into an output language dictionary for each word. In Block 106, the electronic translator may render the translated words based on syntax rules of the output language, and in Block 108, the electronic translator may output to result to the user, through, for example, the user interface, an electronic document, or the like.

However, electronic translation systems that attempt to include rule-based analyses of syntax may still produce substantial errors. For example, the random clustering of words, such as, “colorless green ideas sleep furiously” can be formed from words ordered syntactically correctly, but is nonetheless completely meaningless.

To avoid the drawbacks of word-by-word or syntax analysis, some electronic translations systems employ an understanding of semantics. Used generally, “semantics” includes the study of meaning at the levels of words, phrases, sentences, and even larger units of discourse. These semantics translation systems employ lexicons. Lexicons generally associate words with attributes. When performing a semantic analysis, the translation system reviews the attributes of the words from the input text sequence to determine whether the attributes are consistent. For example, the word “animal” may associate the attribute of being “living,” a stone as “not living,” and “eat” as “living.” Using this kind of semantic check, the system can recognize that a translation of a text sequence that results in “The stone eats grass” includes inconsistent attributes, while a text sequence that results in “The animal eats grass” includes consistent attributes, that is, “animal” and “eat” each include the attribute “living.”

Unfortunately, the electronic translation systems discussed in the foregoing result in limited natural language translation success. Sentences are generally much more complex and translation error rates are high. Some commentators posit that the electronic programming of semantics is not possible, meanwhile many companies are investing huge resources for research in that very same field. To date, electronic translation systems struggle to process natural languages properly.

In addition to the foregoing, development of electronic translation systems are labor intensive and result in one-to-one language pairs. For example, FIG. 2 illustrates a conceptual diagram of language pairs for four (4) languages, English, French, Spanish, and German. However, to translate from any one of the four languages to any other, the translation system actually uses six (6) sets of language pairs, that is, an English-German, English-French, English-Spanish, French-Spanish, Spanish-German, and German-French language pairs.

The complexity of such a system increases dramatically as more languages are added. For example, adding a fifth language, Italian, adds four (4) additional language pairs bringing the total to ten (10) pairs. It is noteworthy that for each pair, complicated dictionaries, syntax, and semantic rule sets use large resources for development. Similarly, in such systems, each translation is undertaken individually even when translate into multiple languages is desired.

### SUMMARY

The present disclosure provides systems and methods that reduce or overcome some or all of the drawbacks of the foregoing translation systems. In one aspect, a system for language translation is provided comprising a meaning representation of language to which languages are linked. Each traditional language system maps syntax and semantics to the meaning representation, often referred to herein as a language-independent “meaning world.” From this language-independent meaning representation, the system can translate into any language paired with the meaning world. In an embodiment, the system can translate into multiple languages paired with the meaning world substantially simultaneously. In an embodiment, the independent language can also link to and/or be output in a graphical or multimedia presentation. In an embodiment, the process of translation may include processing an input text sequence by processing said graphical output or processing data representative of said graphical output.

In an embodiment, information about grammar of the language, including its rules as to how words are arranged, can be developed with respect to the meaning world. The present disclosure includes a relatively straightforward, non-technical process for developing rules. For example, language specific rules can be generated through interaction of a user with a language editor. The language editor may advantageously include quick and efficient language prototyping allowing for straightforward development of new language pairs.

Based on at least the foregoing, embodiments of the present disclosure include a system and method for processing natural language. A system for processing natural language includes one or more data processing devices able to execute a language-independent module, wherein the module manipulates a plurality of objects representing terms and relationships between the objects; a plurality of language-dependent dictionary modules with dictionary entries linked to one of the plurality of objects stored in the language-independent module; a text parser associated with one or more of the language-dependent dictionary modules; and a sentence generator associated with one or more language-dependent dictionaries, wherein the text parser accepts input, extracts key terms from the input, and uses a graph representation of the key terms based on the plurality of objects from the language-independent core module and wherein the sentence generator formulates output text in one of its associated languages based on the graph representation. A computerized method for processing natural language is further provided, wherein the steps of the method include: receiving text input; parsing the text input using a first language syntactic module to extract key terms and relationships between the key terms; translating the key terms into language-independent object terms using a language-independent object world data structure and associations from a first language dictionary module; generating a language-independent graph of the object terms and the relationships; processing the language-independent graph; and outputting the results. Embodiments of the disclosure also include a method of developing such a language processing system that includes; developing a language-independent core, having language term objects that have media representations of language terms, and links between associated language terms; adding a dictionary object, associated with a specific language; adding words from the specific language to the dictionary object; and linking the words to the appropriate core language term objects.

### BRIEF DESCRIPTION OF THE DRAWINGS

A general architecture that implements the various features of the disclosure will now be described with reference to the drawings. The drawings and the associated descriptions are provided to illustrate embodiments of the disclosure and not to limit its scope. Throughout the drawings, reference numbers are reused to indicate correspondence between referenced elements.

FIG. 1 illustrates an exemplary flow chart of a traditional translation process.

FIG. 2 illustrates an exemplary conceptual diagram of an embodiment of language pairs used in a traditional translation process of FIG. 1.

FIG. 3 illustrates an exemplary flow chart of a meaning world translation process.

FIG. 4 illustrates an exemplary conceptual diagram of an embodiment of language pairs used in the meaning world translation process of FIG. 3.

FIG. 5 illustrates an exemplary block diagram of an embodiment of a meaning world translation system.

FIG. 6 illustrates an exemplary block diagram of an embodiment of a meaning world system of FIG. 5.

FIG. 7 illustrates an exemplary flow chart of an embodiment of an add language process for adding a language to the meaning world translation system of FIG. 5.

FIG. 8A illustrates an exemplary flow chart of an embodiment of an add term process for adding a term to a language dictionary in the meaning world translation system of FIG. 5.

FIG. 8B illustrates an exemplary flow chart of another embodiment of a term process for adding a term to a language dictionary in the meaning world translation system of FIG. 5.

FIG. 9 illustrates an exemplary block diagram of an embodiment of a system including one or more translation servers capable of implementing the meaning world translation system of FIG. 5.

FIG. 10 illustrates an exemplary block diagram of an embodiment of a computing system capable of implementing one or more components of electronic systems described herein.

### DETAILED DESCRIPTION

As explained above, the addition of new languages to the language pairing model of translation systems, such as that shown in FIG. 2, quickly becomes complex. In embodiments of the present disclosure, a computer system employs a language independent object world, thereby providing a central hub for language translations. In an embodiment, text or speech is translated from a source language into a language-independent interpretation before translating this representation into one or more destination languages for output.

For example, the language systems of the present disclosure provide a mapping from the syntax and semantics of an input language to, for example, a graph in the language-independent meaning world. From this language-independent representation, the translation can be completed into any language or many languages. In an embodiment, the language independent graph can also link to and/or be output in a graphical or multimedia presentation. An associated translation process analyzes input text (or speech) regarding its syntax and morphology, extracts contents of the text and their relation relative to each other, generates a graph of said text as a language-independent representation of the meaning of said text, and performs processing of said text using said graph.

Such a system is generally in keeping with findings in the neurological field. One basic finding includes recognition that human cognition separates syntax and semantics. For example, if several people with different language understanding are sitting together and with an umbrella in a room, everyone “knows” that the object is an umbrella. But this “knowing” does not mean that the word “umbrella” is activated anywhere in a brain of a person present. When the people in the room want to reference the object, the object “umbrella” is tagged with a language-specific word. The people involved know the object without using language, but they access a “tag” for communication purposes. For instance, they could ask, “May I have this umbrella?”

This separation of syntax and semantics (or of languages dependent information and languages independent information) is a portion of the translation process of the present disclosure. For example, when text is analyzed regarding its syntax and morphology, the grammatical structure is analyzed. This results in a basic understanding of the text. The contents of that text are extracted. For example, the text generally includes sentences which may comprise a subject, object and verb. In an embodiment, each component can be extracted and its function within the sentence can be retrieved. These components and their relation to each other are used in processing the text into a graph. The components form nodes of the graph and the relation between the components are represented by edges. In an embodiment, this graph can be made to be somewhat or completely independent of the language that is used with the input (or output) text. The graph mainly includes semantic information which can be straightforwardly used for further processing.

During analysis of the text, the system accesses information about grammar of the language used. Each language includes its own specific grammar providing rules as to how words are arranged. Another aspect of this disclosure is to provide a relatively straightforward, non-technical way to generate these grammar rules. To enable users that may have little or no programming knowledge to write grammar rules, grammatical data might be entered through a grammar editor. The grammar rules include a certain formalizations of the possible structures of the given language. By that, time-consuming development of different grammars for every single language can be avoided or reduced, and instead, quick and efficient prototyping is possible. That way, new languages can be integrated into a language processing system as disclosed herein more quickly and easily.

In an embodiment, the text analysis is performed by a parser acting at a syntactic layer of a language processing system. In one aspect of the disclosure a language processing system may be configured modularly to enable reusability, adaptability, and expandability of the system. A parser might perform segmentation and tokenization of the text. Segmentation indicates the determination of the sentential units of the text, where tokenization includes the identification of the concrete word forms within the sentence. After performing segmentation and tokenization, the elements as well as their relationship within the sentence can be analyzed in terms of syntax and morphology.

To improve modularity and to gain a process that can be universally used, the syntactic layer objects might be associated with the language processing system. By doing so, different languages can be easily integrated into the language processing system by adding a new parser and dictionary for each language. As the processing within the system is performed with a language independent representation of the text, any language can be processed. Texts in new languages are transformed to the language independent representation, and then any other existing language pairing can be used for the conversion. Thus, the process can be used rather universally.

Each language docked to the language processing system might be represented in a separate set of syntactic layer objects. Thus, syntactical issues can be configured independently of each other. Furthermore, it is possible that single languages can have common syntactic layer objects, such as a parser or major portions of a parser. For instance High German, Swiss German, and Austrian German have mainly common grammar rules. Only several rules will differ. In this case a single parser may handle each language, having most rules common to the several languages and some rules that are language dependent. This reduces the work of changing rules of the single languages.

Language independent information is extracted at this syntactic and/or an optional relational layer. Generally, language independent information comprises objects, actions and attributes and their relations. Objects are usually represented by nouns in languages like German, English or Chinese. Actions are generally described by the verbs of the text. But also adjectives can represent action. For instance two companies can be tagged with “compete” or “competitive.” Attributes can be sensory attributes like color, temperature, size or quality as well as attributes like emotions. These objects, actions, and attributes are extracted from the text by the syntactic or relational layer objects and are translated into the meaning world representations (which can be referred to herein as the semantic layer).

At the step of processing the sentence, objects, actions, and attributes of a sentence or phrase of the text are linked together and represented as a graph. The graph facilitates the processing of the text within the language processing system, as graphs can be easily represented as matrices.

To ensure the language independency of the meaning world system, objects, actions, and attributes can be represented based on a unique ID. However, it is preferable that each meaning world representation of a term also have a picture or illustration of the meaning for ease of working with the meaning world (especially by non-programmers). For instance a car can be represented by a pictogram of a car, a bench can be represented by a pictogram of a bench, the attribute “green” can be a green area, and “to give” can be represented by pictograms of a person handing over an object to another person. Thus, the graphs and meaning world objects can be understood, through the graphical presentations without objects, actions, or attributes being tagged with terms of a specific language.

The step of processing the text might comprise the step of reasoning over the extracted semantics of the text. This can be done by comparing the extracted semantics with a meaning world model or determining the distance between the meaning world objects involved. “Distance” in this instance indicates the relative relation between different objects in the meaning world. Closer objects are those that are directly linked or strongly correlated. The more closely tied a set of objects are within the meaning world, the more likely a translation is going to be correct.

The meaning world comprises language independent term objects (“LIT objects”). The LIT objects main tasks are to represent objects which are usually represented by nouns in languages like German, English, or Chinese. It consists of several two-to-n (2-n) dimensional spaces storing the objects (or prototypes of them) and orders them in meaningful combinations. Other parts of speech, such as verbs, can also be represented by the objects.

In one aspect, the disclosure provides systems and processes for providing translation systems. In this case, a graph, or other semantic representation, of input text is language independent, and it can be the basis of the translation to any language. In general the steps of the process include analyzing the original text regarding its syntax and morphology, using the components of the text and their relations to each other to generate a graph of the text as a language-independent representation. After an optional semantic checking, the language-independent representation is transferred to a textual representation in the target language(s). This step of transferring can be performed by the syntactic layer, as this layer already includes syntactical and morphological information of the target language(s). Each language can be theoretically translated in each other language with minimal added complexity for each new language added to the system. Because there is a language independent platform in between, each language just has to be adapted to the language independent representation. Thus, no dictionaries linking the single languages with each other are necessary (unlike the prior art model described above). This facilitates the development of an automatic translation system.

According to another aspect, the disclosure can provide a process to improve searching in a search engine. For example, a user types a question into the webpage of a search engine. This question is analyzed regarding its syntax and morphology, and the components of the text and their relations are extracted. This information is used to generate an internal graph of the question. Using the language-independent meaning world model, ambiguities can be determined and resolved. Further, by departing from a string-based approach to search queries, single words of the question can be generalized using abstractions like in the structure trees and relations among words. Thus, the quality of the results can be improved.

In yet another aspect, the disclosure provides a process to analyze a text and retrieve information about, for example, the topic of the text. This can be used to categorize a text automatically. Further it can be used to find logical chains or information about semantic structures in the text.

With each embodiment the text generated at the step of processing might be output to the user as written or spoken language or as depiction. If the step of processing comprises the step of analyzing the text, the output can also comprise statistics or a list of topics or input for searching or other processing.

For improving and facilitating the building of the data structures, databases, and representations used within the system, the knowledge used at the steps of the process according to the invention might be input via a web interface. The knowledge might include lexicon tags, content of the meaning world, grammar information, attribute representation or the like. This information can be input by an open group of users who enter the information through a user friendly interface, rather than a programming-type interface.

To facilitate a complete understanding of the invention, the remainder of the detailed description describes the invention with reference to the figures, wherein like elements are referenced with like numerals throughout.

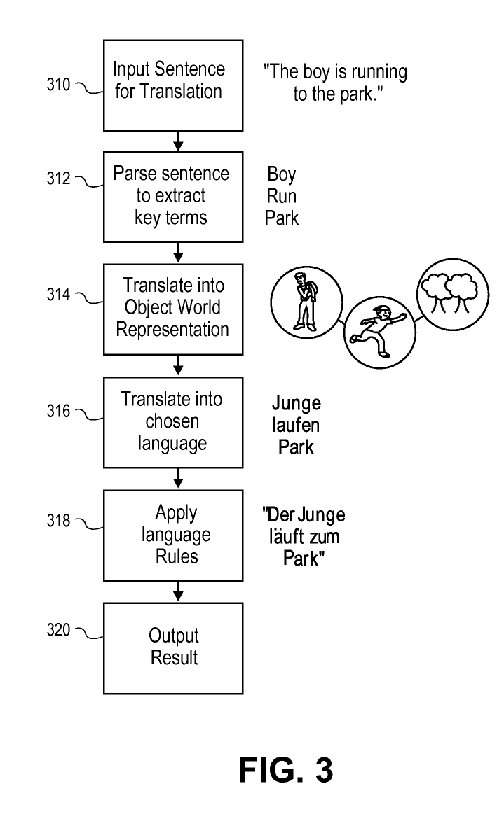

FIG. 3 illustrates an exemplary flow chart of a meaning world translation process 300. As shown in FIG. 3, at Block 310, text of any length, for example a sentence or paragraph, is entered into an electronic translation system according to embodiments disclosed herein. For example, “The boy is running to the park” could be entered at Block 310. At Block 312, the system parses the sentence to extract the root form of the key concepts of the text. Typically, this will be at least the subject, verb, and sometimes object of the sentence. In the illustration, there are three key terms: (1) boy; (2) run; and (3) park. These terms are translated into a language-independent “meaning world” graph (Block 314). In an embodiment, the graph includes a node for each of the key concept terms and an edge to illustrate their connections to the other terms. The key concepts are translated into the chosen language (Block 316). In the example, the destination language is German: (1) Junge; (2) laufen; and (3) Park. A language-specific parser module reforms the sentence with the proper articles, verb forms, and the like (Block 318), and the completed sentence “Der Junge läuft zum Park” is output to the user (Block 320).

Although a simplified example, the process 300 shown in FIG. 3 illustrates the basic concepts of a meaning world and it graphical properties. An artisan will recognize from the disclosure herein many complicating and challenging natural language input scenarios, and as discussed in the following, the meaning world representation provides significant flexibility and power to solve such scenarios.

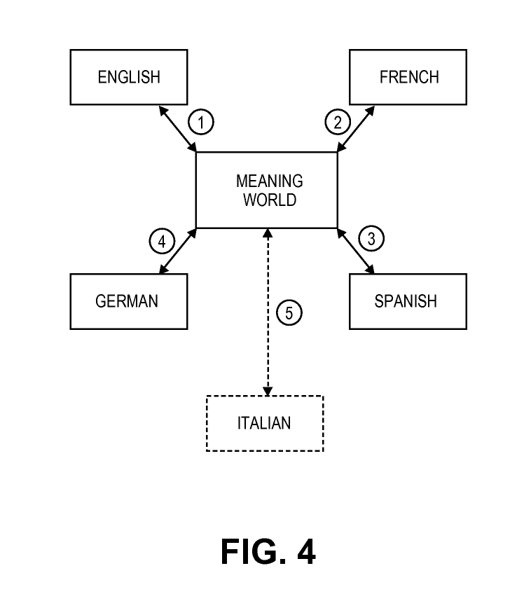

FIG. 4 illustrates an exemplary conceptual diagram of language pairs of the present disclosure. For example, as shown in FIG. 4, the four languages of FIG. 2 use four (4) language pairs as opposed to six (6). In addition, the inclusion of an addition language, Italian, uses an additional language pair. Thus, the difference at five languages is between five (5) language pairs for the present disclosure and ten (10) for that for FIG. 2.

Thus, as indicated by FIG. 4, each language ties to the central meaning world, rather than any other specific language. This provides a modular approach to the translation system, as no language is tied to any other language individually. Moreover, systems and processes according to this disclosure result in a significantly less complex system that is also generally much less costly to develop than the prior art systems.

Embodiments of the present system could, for example, be particularly useful in an international internet chat or instant messaging session. An embodiment of the disclosed system could be incorporated into a back end instant messaging system, and each message could be translated into the preferred language of the individual end users during transmission of the messages. There are numerous other applications for the translation system of this disclosure which will be discussed in more detail below.

Preferably, embodiments of the translation system are characterized by a modular design for multilingual natural language processing and multimodal interaction. Modules dedicated to different languages and others that are language independent can be combined into a working system able to analyze, reason about, search in, translate, and generate natural language. Embodiments of the system handle multimodal interaction: written and spoken natural language input and output, as well as output as language, speech, depiction or a combination of them. The modules preferably are designed in a way to be reusable by other programs as well. Where possible, the modules are language independent, thus aiding in reusability. Well-defined interfaces and general interfacing programs manage the communication between the system components. By this design, every language can be translated into every other language. Languages to be translated also can be variations within a single language, e.g. Swiss German is translated into High German, or colloquial style is translated into formal style. Features of various embodiments may advantageously include some or all of the following:

modularity: easy to handle, reusable, configurable;

web-based: accessible from everywhere;

ergonomically highly sophisticated software: usable by everyone;

community-based: extendable by everyone;

universality: every language can be integrated; and

visual-graphical core: language independent and cognitively adequate.

Embodiments of this disclosure model and simulate human cognitive processing for the optimization of natural language understanding and generation, translation, search engines, or other communication tasks.

A human cognition-based approach, as here, separates syntax and semantics according to the human brain processes, and it differentiates among the multiple meanings of words. Syntactic rules or language-dependent word forms are handled in specific components. Semantics is processed in a language independent layer, referred to as the meaning world. This approach is based on recent findings in neurological research. As discussed in the foregoing umbrella example, the concept of “umbrella” when communicated is the object tagged with the language specific word. The people involved know the object without using language. If they want to go outside while it is raining, they activate the “tag” by means of the language-specific dictionary to communicate with other humans: “May I take this umbrella?” or “Könnte ich diesen Schirm nehmen?”

This helps explain the advantage of the present approach to language processing in that the meaning is represented in a human way and is therefore language independent. All natural languages can be added, since they are using the same meaning world. Not only can this approach be useful for translation, but it can also aid with many other jobs. In an embodiment of the meaning world, information can be added, processed and stored without special language syntax being necessary. As soon as an information unit is present in the meaning world, new languages can be added very easily by means of binding the syntactical representation to the language independent unit.

### Language Processing System

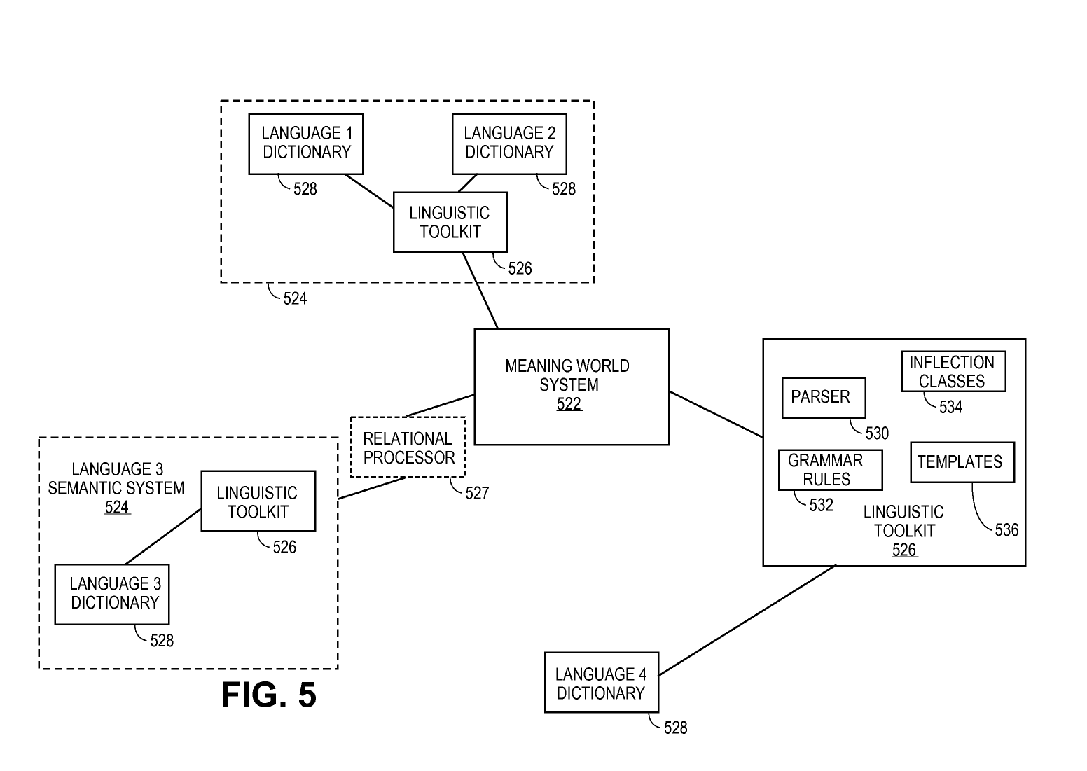

FIG. 5 illustrates and exemplary block diagram of an embodiment of a meaning world translation system. For example, FIG. 5 includes system components or modules that can be used to achieve the language processing and translation system disclosed. The meaning world system 522 includes the language independent representations of concepts. The meaning world system 522 also provides multimedia access to certain users to visualize or hear representations of terms and concepts that are stored within it. As illustrated, each language semantic system 524 is tied to the central meaning world 522. This is accomplished by one or more linguistic toolkits 526. The language semantic systems 524 also comprise one or more language dictionaries 528. Each language represented within the translation system will typically have its own dictionary 528 to provide the specific terms of that language. The dictionary entries are tied to specific objects in the meaning world system 522. In some instances, however, languages may be sufficiently related to be able to share all or parts of a linguistic toolkit 526. For example, various dialects may be represented with different languages, but generally follow similar syntactic rules, such as sentence structure and word order. In this case, a single linguistic toolkit may handle the parsing of each language with some, all, or substantially all grammar rules shared. In an embodiment, a linguistic toolkit provides a parser 530 for extracting terms from sentences to be translated as well as, formulating grammatical sentences from object world graphs. The parser 530 relies on grammar rules 532, inflection classes 534, templates 536, and the like to properly construct and destruct sentences in the associated language. The linguistic tool templates 536 help provide straightforward expansion of the terms in a language dictionary for building or modifying a language within the system. For example, the templates can provide sentence fragments that will help classify new terms properly. More specifically, if a user wishes to add the word “tiger” to the language dictionary, for example, he or she may be presented with templates to help the system understand the parts of speech or a frame of reference. A very straightforward example of a set of templates may be “A tiger,” “I tiger,” and “the tiger ball.” The user can select which one applies, and the system can learn to classify the new term. In this case, the system learns that that “tiger” is a noun that can take an indefinite article, rather than a verb or an adjective, respectively. Similarly, the system may present templates to determine if a verb follows a regular or irregular conjugation. By this process, the system can be extended by everyone without linguistic knowledge being necessary or knowledge about the other languages of the system.

As described above, the parser 530 is a component for translating to and from the meaning world graphs. In another embodiment, however, a relational processor 527 connects the semantic system 524 and parser 530 to the meaning world system 522. In such an embodiment, the semantic system may generate a graph of input text that is still tied to the source language. This graph may be further abstracted into its language independent form by the relational processor 527. The relational processor 527 may extract verb tense, prepositional phrase information, and other sentence details to help organize or augment the language independent graph. For example, the relational processor may indicate “definite article,” “continuous form,” or “directional information” for the example illustrated in FIG. 3. In various embodiments, as will be easily understood by one of skill in the art, the parser 530 and relational processor 527 can be one or multiple modules, act together simultaneously or separately in sequence, and can share responsibilities in any of a number of ways apart from those described herein. Those of skill in the art will also recognize from the disclosure herein that of other configurations that will provide the same or substantially similar functionality.

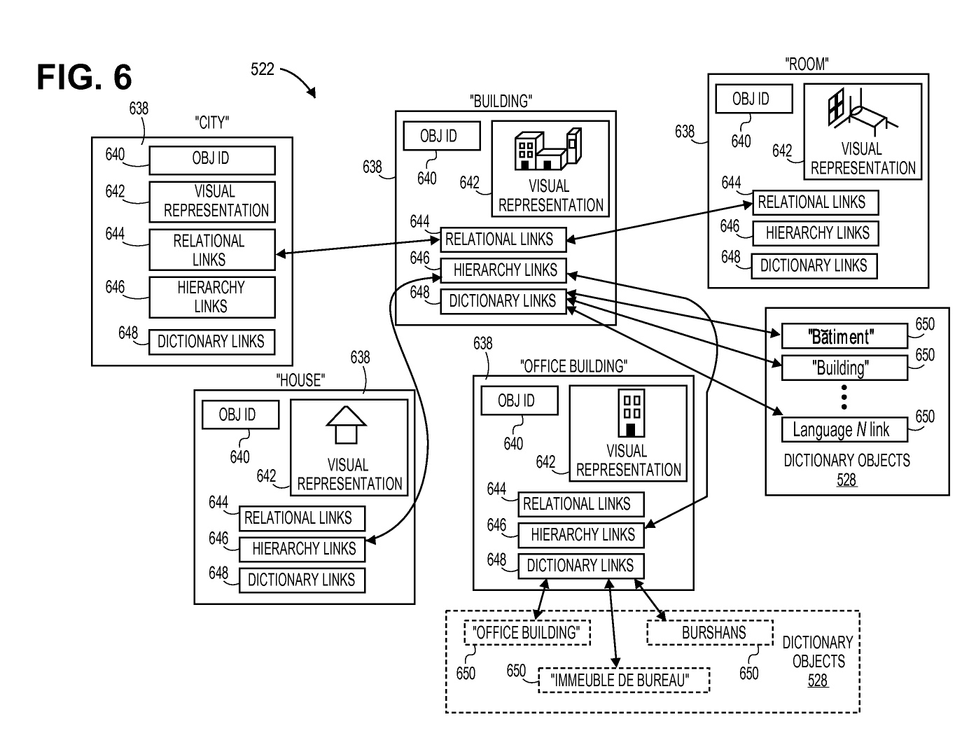

Turning to FIG. 6, an embodiment of the data structures representing the meaning world 522 is illustrated. In general, each LIT object 638 represents a language independent specific term, such as the terms “building,” “room,” “city,” “house,” and “office building” shown in the figure. In an embodiment, each object is a data structure including an object ID 640, a set of one or more relational links 644 and an optional set of one or more hierarchy links 646. The object ID 640 can be a number or code that identifies the computer record in the computer storing the object, but would generally be unrecognizable to a user. In an embodiment LIT objects 638 tie to other related terms using relational links 644. As illustrated, “city” and “building” are related because a city includes a number of buildings; likewise, a “building” is made up of a number of “rooms” so those two objects are linked. In an embodiment, these relational links 644 may be weighted to indicate stronger or weaker ties. Similarly, objects that are related in a class-type-sub-type kind of relationship can be linked by hierarchy links 646 and may form a type of tree structure. In FIG. 6, this relationship is illustrated by the “building,” “house,” and “office building” objects. “Building” is a generic term that encompasses both “house” and “office building” as more specific building types. Although not pictured, “house” itself could then be linked to sub-types “cottage,” “ranch,” and “townhouse,” for example.

LIT objects 638 can also include dictionary links 648. Moreover, dictionary objects 528 include links from the specific language terms 650 to the appropriate LIT objects 638. For example, FIG. 6 illustrates that the term “Bâtiment” from the French language dictionary object 526, the term “building” from the English language dictionary and other included languages would link to the “building” object 638. Similarly, the terms “office building” in English, “Burshans” in German, and “immeuble de bureaux” in French would be linked to the “office building” object 638.

Each object may also include or link to one or more media representations, such as a visual representation 642. The visual representations 642 can be used to illustrate the associated term in a variety of situations. It is particularly useful for users who are helping to add a new language to the system, as it can be displayed for the user to recognize what term they should link to it with the new language dictionary 528. In some embodiments, audio files, video files, picture files, and the like can all be used as associated media representations. For example, “to whistle” may be better associated with a sound file or a sound file and a picture rather than with just a visual representation.

Attributes of objects can also be linked in the object world system 522, and may have special relational ties. For example, an attribute may be an emotional scale, a color representation, or physical attributes like temperature, size, or quality. Relational ties may allow specific terms to be placed along a scale, so that related terminology can be tied to specific or relative values along the scale. For example, “tiny,” “small,” “regular,” “large,” “huge,” “enormous,” and “infinite” might all fall along a size scale. The attribute space itself can be multidimensional. Attributes can also be represented in a structure tree, e.g. “scarlet,” “carmine,” and “crimson” are subtypes of “red.” That way the units of the meaning world are connected to each other in multiple ways in a network allowing complex deductions necessary for processing natural language.

### Meaning World Representation

Moreover, in an embodiment, the meaning world system 522 can be represented as a virtual world or a set of virtual worlds. For example, a user interface may be provided that would allow a user to walk through a virtual representation of a meaning world system 522. A user may, for example, first see a “city” made up of “buildings” and be able to zoom into any specific building, such as a “house” or “office building.” From there, the user may be able to walk into a “room” of the house, and each room may have objects representing other terms such as “couch,” “chair,” “bed,” “table,” and the like. Each object can also be tagged to display the language representations of the terms that are linked to that LIT object 638's dictionary links 648. The virtual world can also include representations of people and actions, as well as modifying attributes. Therefore, navigating to a “door” object in a virtual world may display not only a “door” English tag, but also a “red” color tag, a “wooden” tag, and the like.

In another embodiment, multiple “worlds” may exist with links between them. Straightforward objects can open up new worlds. For example, a room scene may depict a window with the moon showing outside. Clicking on the moon could then lead to another object world that is space oriented. A representation of a human being can lead to an object world that simulates the cellular basis or body parts of human beings. If a user navigates to an office in an office building, there may be a representation of papers on a desk, navigating to the papers (such as by clicking on them with a curser and a mouse input tool, for example) may also open up a tree interface to show the object 638 connected through the hierarchy links 646. For example, “paper” may be related to “advertisement,” “report,” “periodical,” and the like. In turn “periodical” may link to “newspaper” and “magazine” and so on.

Navigation through such a world can be a useful learning tool in and of itself because a user can elect to view language tags in whatever languages are connected to the meaning world. In an embodiment, a user may elect to view tags for a language that they wish to know in order to help them learn that language. Similarly, in an embodiment, terms in a user's primary language and another language may be displayed so that the user can correlate the two along with the visual representation.

Various relations between objects 638 in the meaning world 522 can also be modeled graphically. Spatial, temporal, causal, or metaphorical relations between meaning world objects 638 (and also the other types of relations) are ideally suited for a graphical depiction. For translation, these kinds of relations are the base for determining by which structures and wordings they are to be expressed verbally because languages differ in the way they express these relations: some languages use prepositions, others realize them as morphemes attached to a noun, etc. The best way to generate adequate structures and wordings is based on a neutral, abstract, and graphical representation. By this process, the generation component doesn't need to do a complex restructuring of the input structure (as is done by classical machine translation systems), but simply chooses between the available structures of the target language using a mapping from relations to structures.

Returning to the translation process of FIG. 3, additional detail can now be explained with respect to the meaning world system 522. When selecting proper translations, knowledge about the topics involved improves the translation by filtering ambiguous meanings that do not belong to these topics. The topics can often be discerned from the relations of the translation text's graphical representation (see Block 314). For several topics, there will be many clusters in the N-dimensional semantic space. Efficient and fast clustering algorithms are used to find the cluster centers like the k-means clustering algorithm. These Cluster centroids represent the topics of the text. If there are ambiguous translations, the topic can be used to resolve them. For example, an input text may include, “The dog was a Siberian Husky.” The term “dog” actually has multiple meanings including “a domesticated canine, “a despicable man,” or “an iron bar driven into a stone or timber to provide a means of lifting it.” Each of these definitions may have different translations in other languages and are therefore also ambiguous to the object world system 522. However, the context of the sentence can help select the correct object world object to use (the one that corresponds to “a domesticated canine”) because the other objects of the sentence, in particular “Siberian Husky,” would be more closely tied in the object meaning world with that object than with the others. Conceptually, “Siberian Husky” and the proper “dog” object would both appear in an animal or pet-related subset of the object world, for example.

The syntactic analysis of the text often creates many syntax graphs and some unresolved connections between graph nodes, as in the above “dog” example. A statistical approach to choose the best graph is generally used to distinguish between ambiguities: Bayes' theorem, in an embodiment. Bayes' theorem states that the probability of a certain graph given the evidence (the semantic entities) is proportional to the likelihood of the semantic entities to be in that graph times the prior probability of that entity being in that graph. Other algorithms and statistical analysis—known as or derived from standard statistical principals—can also be used to help disambiguate translations from a source language to the LIT object interpretation and will be known to those of skill in the art.

### Language Building

One aspect of an embodiment of the language processing system disclosed is a set of tools that can help a user edit languages or add new ones altogether. As already explained, users can navigate through a virtual world that helps represent terms included in the language independent meaning world. It would be of great use to allow multiple interested parties to help add new language terms, correct misused terms, and even add new languages to the meaning world. While all of this can be done by skilled programmers, it would be quicker and easier to allow the collective abilities of a great number of users grow and correct the meaning world. This type of group work has already been illustrated with the “wiki-” movement and websites such as “Wikipedia.” In an embodiment, selected, qualified users, such as linguists, language professors, and the like, would be allowed to add languages or edit existing ones; in another, any interested user may be allowed to add or edit a language.

In an embodiment, the system creates a certain formalization of possible structures of the language. By that, time-consuming development of different grammars for every single language can be avoided and instead, quick and efficient prototyping is possible. In that way, new languages can be plugged in quickly and easily. The grammars are used by both the language analysis and generation components.

Additionally, graphical user interfaces, which may be called Lexi-Wikis, allow users to enter words into the language-specific dictionaries 528. Lexi-Wikis are designed to be usable by everybody. From the respective words, the tools generate example sentences to be simply selected or modified by the user. Which forms and how many word forms have to be presented to the user is determined by different language-specific inflectional algorithms. The user-selected examples are translated into a complex representation which can be processed by the program. In an embodiment, the underlying morphological process uses linguistic knowledge and frequency information to determine the minimum of information the user has to provide. It thus anticipates the most probable word forms so that as few as possible word forms and as few as possible actions are required from the user. By this process, the mental load or the intelligence is transferred from the user side to the software side.

Very often users will not be able to position semantic entities absolutely, but they will very well be capable of telling the dissimilarity to other semantic entities. Multidimensional scaling is employed, an algorithm designed to place multidimensional points based on a dissimilarity matrix, that is a matrix containing the distances (or dissimilarity) to other semantic entities. These algorithms can be fuzzy, which is necessary, as no two people will choose exactly the same distance. They will rather have a consensus of a general strength (as in “far away” or “very close to”).

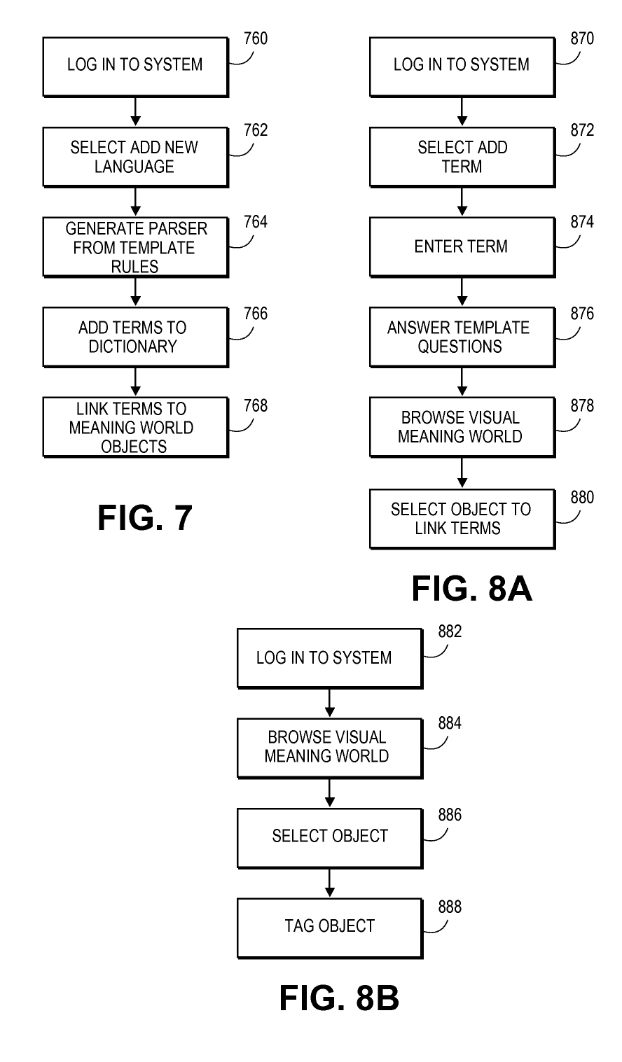

Turning to FIG. 7, a process of adding a language to a meaning world system is described. In Block 760, a user logs on to the system. In some embodiments, the user may elect to log into a specific “user modification” mode, which can help prevent unauthorized or inadvertent alterations to the system. From a menu, the user may elect to add a new language (Block 762). In creating a new language, a syntax parser must be created to deconstruct and generate sentences. In an embodiment, the system includes template rules that the user can select when applicable (Block 764). For example, a rule may indicate that adjectives typically modify a noun coming after them (e.g., English) or that they typically modify a noun coming before them (e.g., French). Modifying rules can explain exceptions to this and the like. Once a parser is created, terms can be added to the new language's dictionary (Block 766). Each term is linked to meaning world objects (Block 768).

Linking new terms can be done in any number of ways, including the processes described with reference to FIGS. 8A and 8B. In one embodiment, a user logs into the system (Block 670) and chooses to add a term to a specific language dictionary (Block 872), such as through a menu system. The user can enter the term (Block 874). The system may provide template questions to help provide proper usage context (Block 878). For example, templates can help the system categorize the terms by part of speech, regular or irregular conjugation of verbs, and the like. The responses may also help provide a specific meaning world context to help direct the user to the correct meaning world or area of the meaning world in which the term's language independent object resides. The user can also browse the virtual meaning world (Block 878) and select the virtual representation to which the new dictionary entry should be linked (Block 880).

In an alternative embodiment, FIG. 8B illustrates another process by which a user can add words to the dictionaries. As shown in FIG. 8B, the user logs onto the system (Block 882). The user may browse the meaning world (Block 884). Selecting objects in a specific context (Block 886) can display the terms that are linked to that object, such as by showing a pop-up balloon in the virtual world. When a user selects an object, if no term is associated, the user may add a term to “tag” the object (Block 888). Similarly, a user may alter tags to correct or enhance language dictionaries. For example, a meaning world representation of a saxophone may be tagged with the term “instrument” or “musical instrument” in the English dictionary. A user may edit the tag to show the more precise term in the hierarchy by adding “saxophone.”

Moreover, external resources can be linked into the system so that knowledge representations available on the Internet, in public or private databases, and the like can be used within the components of the language system. Resources to be linked may include, for example, DBpedia, Wiktionary, Open Street Map, scientific taxonomies, ontologies from the Semantic Web®, users own taxonomies, etc. In an embodiment, consistency check components verify the consistency of different representations and enable correct computing over potentially heterogeneous knowledge sources. Even different media types can be integrated such as graphics, videos, and audio.

### User System Access

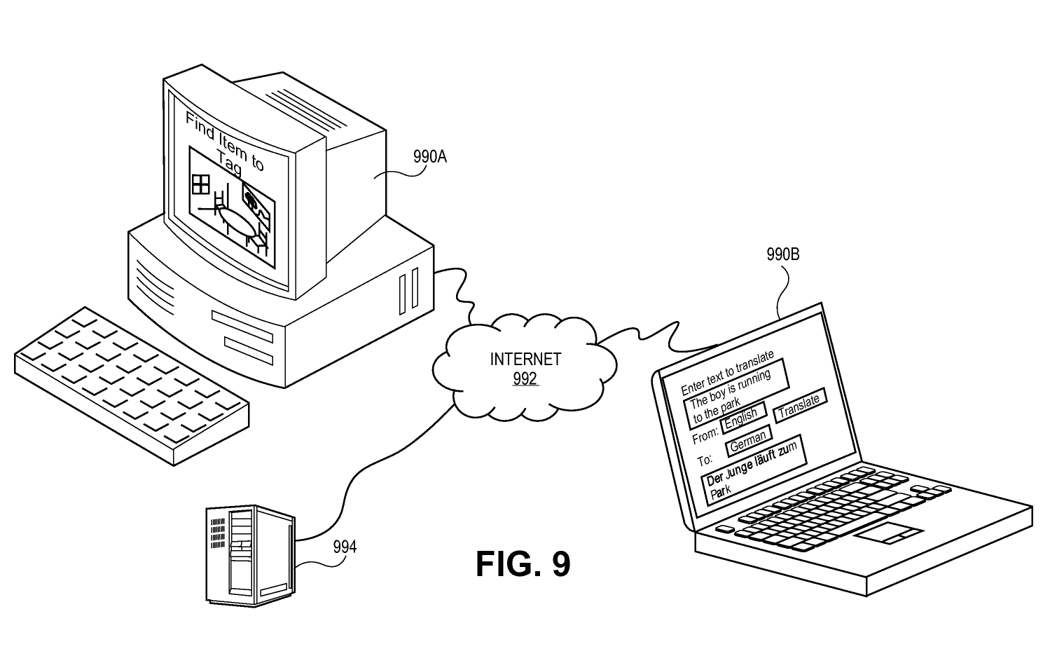

Turning to FIG. 9, an embodiment of a basic translation system and means for accessing it are illustrated. Although such a translation system can take many forms a web-based translation system can provide easy access for a large number of interested users. For example, a computing system 994, such as a server, may store some or all of the programming code that when executed produces some or all of the functionality of the meaning world system 522, including the language semantic systems 524. The server 994 may electronically communicate with a public or private, local or wide area network 992, such as, for example, the Internet. In turn, various users can electronically communicate with to the translation computing system using other network-enabled devices 990a, 990b. Suitable user devices include personal computers, laptop computers, data network enabled phones or other mobile devices (such as, for example, Blackberry® devices, Apple iPhone® devices, other PDAs, mobile phones, and the like). Users may access the translation system through a web interface through a browser or through a stand-alone program installed on the user device, in some embodiments.

One user may use a personal computer 990b to access a translation service, input text for translation, select source and destination languages, and receive the appropriate translated text as described with reference to FIG. 3. Meanwhile, another user may edit or add languages to the system through a different interface on their computer 990a. The language translation system is preferably scalable to allow a number of users to access the system at any given time. With this approach, multiple users may attempt to edit languages simultaneously. In a preferred embodiment, the translation system may provide a lockout mechanism to allow only one user to edit a specific dictionary 528 entry or a specific meaning world LIT object 638, for example, at any given time.

### Other Applications

Although much of this disclosure focuses on the use of the meaning world and language parsing abilities in order to create a translation system, there are other uses for such a meaning world system. For example, the meaning world system can help enhance search engine capabilities. An embodiment of the system as described herein can parse a natural language search query, such as a sentence or a question. It can extract key terms and generate graphs and/or graphical language independent equivalents. Because these language independent objects 638 are also linked to related LIT objects, a user's straightforward question can be expanded to include similar words, other word forms, semantically related words, and the like.

As an example, a user types a question into the webpage of a search engine: “What recent court decisions define qualifying income tax?” This question is analyzed regarding its syntax and morphology, and the components of the text and their relations are extracted: “court,” “decision,” “define,” “qualifying,” and “income tax.” This information can then be used to generate a graph of the question, as if a translation were being made. These terms or meaning world objects 638 alone may not provide all topical results, however. As such the object world relational and hierarchy links 644, 646 can be used to expand the search terms. For example, “decision” may link to the term “opinion” and “order.” Similarly, “court” may link to “judge,” and “income tax” could link to “IRS.” These additional terms can then be used to expand the ultimate search. Thus, the quality of the results can be improved without the user having to expand their terminology or perform multiple searches.

Another aspect of this disclosure can be used to analyze a text. It is possible to use the parsers to retrieve the topics presented in a text. This can be used to categorize a text automatically. Further it can be used to find logical chains or information about semantic structures in the text. Continuing the example from above, this text analysis could be used by a web-crawler program that attempts to categorize new web pages for searching purposes. When analyzing text, output can comprise statistics or a list of topics that may be used to tag web-pages for a search query. Similarly, libraries could use a similar system to help categorize new books, periodicals, articles, and the like to generate topical card catalogues and search databases.

Similarly, topic extraction can help expand search queries in a correct environment. For example, “decision” from the above search query could also link to “choice,” while “court” could link to “basketball” or “tennis.” Expanding a search with these terms would clearly be expanding the search into an improper object world space. Thus determining that the topic is “taxes” and/or “legal” can help a search engine expand terms in an appropriate context.

Further embodiments are possible. As the disclosure offers a language independent representation of a text, the processing of that representation can take many different forms. Thus, the disclosed system can be used in many different applications. Further, various embodiments described herein can be combined as desired.

### Computer Hardware

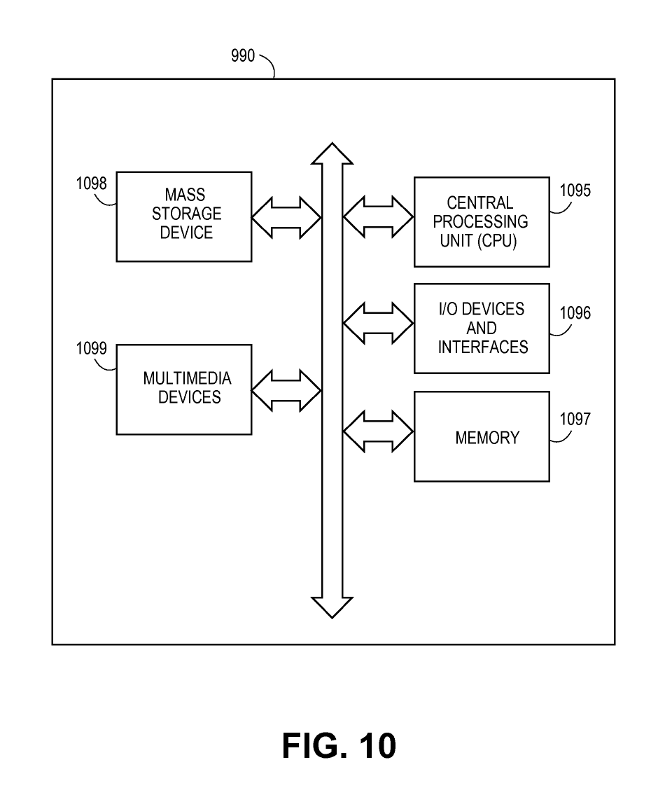

FIG. 10 illustrates a block diagram of one embodiment of a computing system 994 that may be used to implement certain systems and processes described herein. For example, in one embodiment the computing system 994 may be configured to receive translation requests from another computer system (such as a user PC 990a, 990b), use a meaning world implementation to translate the request into the proper language, and return the translation. The functionality provided for in the components and modules of computing system 994 may be combined into fewer components and modules or further separated into additional components and modules.

The computing system 994 includes, for example, a server or personal computer that is IBM, Macintosh, Linux/Unix compatible, or the like. In one embodiment, the computing device comprises a server, a laptop computer, a cell phone, a personal digital assistant, a kiosk, or an audio player, for example. In one embodiment, the exemplary computing system 994 includes a central processing unit (“CPU”) 1095, which may include a conventional microprocessor. The computing system 994 further includes a memory 1097, such as random access memory (“RAM”) for temporary storage of information and a read only memory (“ROM”) for permanent storage of information, and a mass storage device 1098, such as a hard drive, diskette, or optical media storage device. Typically, the modules of the computing system 994 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 994 is generally controlled and coordinated by operating system software, such as Windows 95, Windows 98, Windows NT, Windows 2000, Windows XP, Windows Vista, Linux, SunOS, Solaris, or other compatible operating systems. In Macintosh systems, the operating system may be any available operating system, such as MAC OS X. In other embodiments, the computing system 994 may be controlled by a proprietary operating system. Conventional operating systems control and schedule computer processes for execution, perform memory management, provide file system, networking, and I/O services, and provide a user interface, such as a graphical user interface (“GUI”), among other things.

The exemplary computing system 994 includes one or more commonly available input/output (I/O) devices and interfaces 1096, such as a keyboard, mouse, touchpad, modem, Ethernet card, microphone, and/or printer. In one embodiment, the I/O devices and interfaces 1096 include one or more display devices, such as a monitor, that allows the visual presentation of data to a user. More particularly, a display device provides for the presentation of GUIs, application software data, and multimedia presentations, for example. The computing system 994 may also include one or more multimedia devices 1099, such as speakers, video cards, graphics accelerators, and microphones, for example. In an embodiment, a user enters text to be translated or processed through a keyboard or touchpad representation of a keyboard (input devices 1096). In another, a microphone (another input device 1096) accepts spoken text. The spoken text may be stored in any of a number of audio formats, such as for example, WAV, MP3, or other formats. The CPU 1095 may process this audio text and convert it to written text, such as a string data object, a plain text data file, a Microsoft® Word document, or the like.

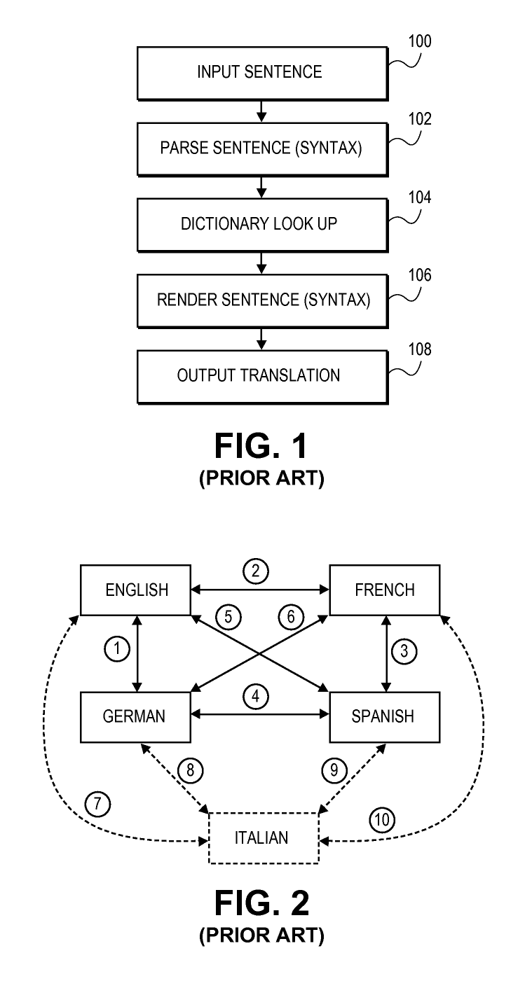

In the embodiment of FIG. 1, the I/O devices and interfaces 1096 provide a communication interface to various external devices. In an embodiment, the computing system 994 is coupled to a network 992, such as a LAN, WAN, or the Internet, for example, (see FIG. 9) via a wired, wireless, or combination of wired and wireless, communication link. The network 992 communicates with various computing devices and/or other electronic devices via wired or wireless communication links. In the exemplary embodiment of FIG. 9, the network 992 is coupled to one or more user terminals or computing devices 990a, 990b. Computing device 990b can communicate the text input, in audio or written text formats, to computing system 994 for processing. In addition to the devices that are illustrated in FIG. 9, the network 992 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 10, the computing system 994 also includes an application module that may be executed by the CPU 1095. In the embodiment of FIG. 1, the application module manages the meaning world models and data. This module may include, by way of example, components, such as software components, object-oriented software components, class components and task components, processes, functions, attributes, procedures, subroutines segments of program code, drivers, firmware, microcode, circuitry, data, databases, data structures, tables, arrays, and variables.

In general, the word “module,” as used herein, refers to logic embodied in hardware or firmware, or to a collection of software instructions possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Although the foregoing has been described in terms of certain specific embodiments, other embodiments will be apparent to those of ordinary skill in the art from the disclosure herein. Moreover, the described embodiments have been presented by way of example only, and are not intended to limit the scope of the disclosure. Indeed, the novel processes and systems described herein may be embodied in a variety of other forms without departing from the spirit thereof. For example, any of a variety of data structures or combinations of various data structures can be used for storage and processing of the meaning world 522, its objects 638, and the like. While a graph structure was described to illustrate meaning world representations of text being processed, matrices, linked lists, and records are a few examples of data structures that could implement the same idea.

Accordingly, other combinations, omissions, substitutions, and modifications will be apparent to the skilled artisan in view of the disclosure herein. In addition, the language independency of the meaning world may advantageously be completely, substantially, or only moderately independent of any particular language, or include one or more languages native thereto.

Thus, the present disclosure is not limited by the preferred embodiments, but is defined by reference to the appended claims. The accompanying claims and their equivalents are intended to cover forms or modifications as would fall within the scope and spirit of the disclosure.

What is claimed is:

1. A system for processing natural language including one or more data processing devices individually or together configured to execute software comprising:
a language-independent module, wherein the module manipulates a plurality of objects representing terms and relationships between the objects;
a plurality of language-dependent dictionary modules, each dictionary module having a plurality of entries, each entry of the dictionaries linked to one of the plurality of objects stored in the language-independent module;
a text parser associated with one or more of the language-dependent dictionary modules; and
a sentence generator associated with one or more of the language-dependent dictionary,
wherein the text parser accepts input, extracts key terms from the input, and uses a graph representation of the key terms based on the plurality of objects from the language-independent core module and wherein the sentence generator formulates output text in one of its associated languages based on the graph representation.

2. The system for processing natural language of claim 1 wherein the input comprises written text.

3. The system for processing natural language of claim 1 wherein the input comprises oral text.

4. The system for processing natural language of claim 1 comprising at least one linguistic syntactic module associated with one or more of the language-dependent dictionaries, the linguistic syntactic module including the text parser, a set of grammar rules, and a set of templates.

5. The system for processing natural language of claim 4 wherein each language-dependent dictionary is associated with a different linguistic syntactic module.

6. The system for processing natural language of claim 4 wherein the language-dependent dictionaries of at least two closely related languages are associated with the same linguistic syntactic module.

7. The system for processing natural language of claim 1 wherein the language-independent module further stores media representations of associated terms stored in the module.

8. The system for processing natural language of claim 7 wherein the media representations comprise pictures.

9. The system for processing natural language of claim 7 wherein the media representations comprise sounds.

10. The system for processing natural language of claim 7 further comprising an editing component module, wherein the editing component module facilitates the alteration of the dictionary entries and their links to the one of the plurality of objects stored in the language-independent module.

11. The system for processing natural language of claim 10 wherein the editing component module is further adapted to facilitate adding entries to the plurality of language-dependent dictionaries.

12. The system for processing natural language of claim 10 wherein the editing component module is adapted to be accessible from a website.

13. The system for processing natural language of claim 12 wherein the media representations of terms can be displayed within a virtual world.

14. The system for processing natural language of claim 12 wherein the editing component module restricts access to qualified users.

15. A computerized method for processing natural language, the steps of the method comprising:
receiving text input;
parsing said text input using a first language syntactic module to extract key terms and relationships between the key terms;
translating the key terms into language-independent object terms using a language-independent object world data structure and associations from a first language dictionary module;
generating a language-independent graph of the object terms and the relationships;
processing the language-independent graph; and
outputting the results.

16. The computerized method of claim 15 wherein the processing step comprises translating the language-independent graph into a second language using a second language dictionary module and a second language module and the results are output text in the second language.

17. The computerized method of claim 15 wherein the processing step comprises generating a search query.

18. A method of developing a language processing system comprising:
developing a language-independent core, the core comprising language term objects, each language term object comprising media representations of language terms, and links between associated language terms;
adding a dictionary object, associated with a specific language;
adding words from the specific language to the dictionary object; and
linking the words to the appropriate core language term objects.

19. The method of building a language processing system of claim 18 wherein the links between associated language terms include relational links and hierarchy links.

20. The method of building a language processing system of claim 18 comprising creating a language parser for the specific language based on grammar and syntax rules.
